(19) United States
(12) Patent Application Publication
(10) Pub. No.: US 2011/0166486 A1
(43) Pub. Date: Jul. 7, 2011

(54) Compact and light weight portable transducer massager

(76) Inventor: Norio Kumanomido, Omiya (JP)

(21) Appl. No.: 12/833,944

(22) Filed: Jul. 10, 2010

(30) Foreign Application Priority Data
May 1, 2009 (JP) 3152063

(51) Int. Cl. A61H 1/00; H02M 7/42

(52) U.S. Cl. 601/15; 363/13

(57) ABSTRACT

An electric massager comprising an enclosure box that contains a reverse structure of audio speaker less a speaker diaphragm, the said reverse structure in the box comprising two metal plates sandwiching a permanent magnets, a coil-cone and a thin metal leaf spring connecting to the said magnet and to the enclosure box. The said massager as a kit includes a separate AC/AC transformer, and as an optional item, a DC/AC inverter for an automobile use. When the said coil is energized by the AC/AC transformer or the DC/AC inverter, the said sandwiched magnet vibrates at a given AC frequency. The vibration is transferred to the enclosing box via the said leaf spring so that the enclosure box vibrates and the heat generated by the coil is trapped within the enclosure box and warms the box, the massager.

### BACKGROUND OF THE INVENTION

This invention relates generally to massaging device and more particularly to portable electric massager.

Almost all prior art electro-mechanical massagers utilize electric motor and or solenoid as the means of creating a massaging motion. Typically, the conventional motor or solenoid based massagers are noisy, bulky and heavy, because they require motor(s) and other parts such as wheels, gears, disks, or balls, and if they are to be heated, additional electrical heating devices, which add more weight, bulk and cost. The objective of the this invention is to produce a massager that is simple in structure, compact in size and weight, low in production cost, yet delivers strong and effective massaging vibrations. One massager that attempted to solve the above said problems was invented by the same inventor of this present invention, Norio Kumanomido, Tokyo, Japan. It is called “Vibratherapy”, Japanese Pat. No. 2938210. It has no motor or solenoid, but has a radically new “engine” of vibration. The “engine” is basically a reverse structure of an audio speaker without the speaker cone. The Vibratherapy has two large “engines”, however, it is rather heavy, bulky, costly and does not have a desirable heating capability. This new invention is to solve those problems by using only one “engine”, lighter materials, a special coil and the necessary AC/AC transformer that enables the coil to generate heat and warm the massager. It can also be used in a car with an optional DC/AC inverter that plugs into the cigarette lighter socket.

### SUMMARY OF THE INVENTION

This invention is an improvement on the previous invention of a massager,” Vibratheraphy”, invented by Norio Kumanomido, the inventor of this new massager. The objective of this invention is to make compact, light-weight and heat generating massager at low cost without motor or solenoid and without a separate heating element. To accomplish the objective the structure of audio speaker was reversed, and the sound producing cone was eliminated. A speaker creates sound waves by moving back and forth a speaker coil/cone combination, while keeping a heavy magnet in a stationary position. By reversing the structure the said new massager vibrates a solid magnet by fixing a coil in a stationary position and by transferring the heat generated by the coil to the surface of the massager. The massager of the present preferred embodiment comprises an outer enclosure cover, a bottom enclosure cover, two solid magnetizable metal plates, which sandwich a solid doughnut shaped magnet, a doughnut shaped thin metal spring that is attached to both the magnet and the enclosure cover, a coil, a specially designed step-down AC/AC transformer adaptor, and a DC/AC inverter as an optional accessory for use in an automobile. The specific construction of the said ne massager will be discussed below in detail with a drawing, FIG. 1. The vibration cycle of the massaging motion is the same as that of a house current, nominally 50 Hz or 60 Hz, and the said preferred embodiment of the massager delivers a temperature of 40+/−° C. , but not limited to that temperature since the degree of temperature corresponds to the degree of AC voltage: the higher the voltage, the higher the temperature.

### BRIEF DESCRIPTION OF THE DRAWING

FIG. 1

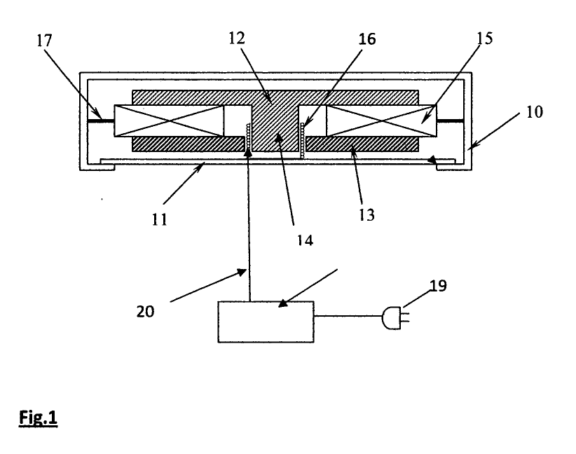

List of Parts shown in the drawing, FIG. 1

1. Plastic enclosure cover 10

2. Non ferric metal bottom cover 11

3. Magnetizable top plate 12

4. Magnetizable bottom plate 13

5. Cylindrical shaft 14

6. Doughnut shaped magnet 15

7. Coil 16

8. Doughnut shaped thin metal spring 17

9. AC/AC Transformer 18 or DC/AC inverter for a car

10. Input power cord 19

11. Output power cord

### DESCRIPTION OF THE PREFERRED EMBODIMENT OF THE PRESENT INVENTION

Referring to FIG. 1, the present invention comprising a plastic enclosure cover 10, a non-ferric metal bottom cover 11, within the enclosure a magnetizable top plate 12 with a cylindrical shaft 14 extending downwardly so as to form a “T” shape, a magnetizable bottom plate 13 having a center hole of which diameter being larger than that of a coil 16, a doughnut shaped magnet 15 which being sandwiched and firmly fixed between the said topr plate 12 and the bottom plate 13, a coil 16 which is firmly fixed onto the non-ferric metal bottom cover 11, a doughnut shaped thin metal spring 17 of which outside perimeter being tightly attached to the inside side-wall of the said top enclosure cover 10 and the inside perimeter of the said spring 17 being tightly attached to the outer perimeter of the said magnet 15, a step-down AC/AC transformer adapter 18 with a specially designed circuitry that delivers a voltage and amperage necessary for the said coil 16 to generate desired and effective heat. The said adapter 18 has an input power cord 19 that connects to the house power outlet and output power cord 20 that plugs into the said massager. The diameter of the said center shaft 14 being smaller than that of the said coil 16, so that the entire assembly of the said top plate 12, said magnet 15 and said bottom plate 13 vibrates up and down freely as a single unit, and the vibration is transferred via the said spring 17 to the enclosure body so that the enclosure itself also vibrates. The said top and bottom enclosure 10, and 11, respectively, are made of non-magnetizable material, such as plastic and/or non-ferrous metals that have excellent heat transmission. The heat generated by the said coil 16 warms the air inside the enclosure and the enclosure body. To use the massager in a car an optional DC/AC inverter (not shown) is available that could be plugged into a cigarette lighter socket.

The embodiment of the invention in which an exclusive or privilege is claimed are defined as follows:

1. A massager comprising a top enclosure box, the enclosure box containing a top metal plates with a center shaft forming a “T” shape when viewed from a side, a bottom metal plate with a center hole of which diameter greater than that of the center shaft of the top metal plate, a permanent magnet with a center hole of which diameter greater than that of the center hole of the bottom plate, a coil-cone with its diameter greater than that of the center shaft of the top plate but smaller than the diameter of the center hole of the of the bottom plate, a thin metal leaf spring tightly surrounding the magnet and firmly affixed to the perimeter of magnet and to the side wall of the enclosure box, the said two metal plates firmly sandwiching the permanent magnet with the center shaft of the top plate extending downwardly through the coil-cone which is affixed to the bottom cover of the enclosure box.

2. An AC/AC transformer with the input voltage of a house current and the output voltage and amperage being substantially lower than the input voltage for the safety reason, the input voltage and amperage being nominally 5V-12V, and 500 mA-1200 mA, respectively, but not limited to the above voltage and amperage, yet the said coil being able to generate sufficient and comfortable heat and being able to transfer the heat to said enclosure box.

3. A 12V DC/AC inverter for an automobile use having the same characteristic voltage and amperage of the said AC/AC transformer adapter.
